(19) United States
(12) Patent Application Publication
(10) Pub. No.: US 2025/0146143 A1
(43) Pub. Date: May 8, 2025

(54) AMMONIA PRODUCTION

(71) Applicant: Plasmaleap Technologies Pty Ltd, Marrickville (AU)

(72) Inventors: Patrick Joseph CULLEN, Sydney (AU); Tianqi ZHANG, Marrickville (AU); Renwu ZHOU, Marrickville (AU); Fengwang LI, Marrickville (AU)

(21) Appl. No.: 19/016,581

(22) Filed: Jan. 10, 2025

Related U.S. Application Data
(63) Continuation of application No. PCT/AU2023/050642, filed on Jul. 12, 2023.

(30) Foreign Application Priority Data
Jul. 13, 2022 (AU) 2022901953

(51) Int. Cl. C25B 1/27; C25B 9/09; C25B 9/23; C25B 11/032; C25B 11/075; C25B 15/08

(52) U.S. Cl. CPC C25B 1/27; C25B 9/09; C25B 9/23; C25B 11/032; C25B 11/075; C25B 15/083

(57) ABSTRACT

An apparatus is provided including a discharge zone configured to accept a gas flow therethrough, a high voltage electrode capable of generating a high voltage discharge within the discharge zone, and an electrolysis zone bounded by a second electrode and a third electrode. In the apparatus, the second and third electrodes are low voltage electrodes, and the second electrode is gas permeable and separates the electrolysis zone from the discharge zone.

### CROSS REFERENCE TO RELATED APPLICATIONS

This application is a continuation of International Application No. PCT/AU2023/050642, filed Jul. 12, 2023, which takes priority from Australian Provisional Patent Application No. 2022901953, filed Jul. 13, 2022, the entire contents of each of which are incorporated by reference herein.

### TECHNICAL FIELD

The invention relates to the production of Ammonia.

### BACKGROUND

The growing research interest in electrochemical synthesis for converting excessive energy to renewable energy storage and chemicals has been motivated by the global push towards a sustainable and decarbonized world. Typical electrochemical conversion examples include nitrogen reduction, carbon dioxide reduction, methane oxidation reaction and oxygen reduction reactions.

One of the most attractive focuses is the ammonia economy, the core of which is based on nitrogen reduction reactions (NRRs). The Australian government has announced a national hydrogen strategy, which targets a clean, innovative, safe and competitive hydrogen industry. Ammonia, with its superior advantages of high hydrogen content (17.6% wt), ready liquefaction (−33° C. at standard pressure) and zero carbon emission properties, is a clean fuel to support the strategy.

The nature of highly stable nitrogen molecules remains a challenge for further increasing the production rate and energy yield of ammonia synthesis.

Nitrogen fixation through the Haber-Bosch (H-B) process laid the foundation of modern agriculture and supported a growing population in the past century. However, the intrinsic characteristics of the conventional H-B process are not compatible with renewable energy power-to-X (P2X) strategies, which provide a new-generation platform for storing excess renewables for end-users, including decarbonized green fuels and chemicals.

There is therefore a need for a scalable (up-scalable and/or down-scalable), preferably low energy, process for generating ammonia.

### SUMMARY

In a first aspect of the invention there is provided an apparatus comprising a discharge zone configured to accept a gas flow therethrough, a high voltage electrode capable of generating a high voltage discharge within the discharge zone, and an electrolysis zone bounded by a second electrode and a third electrode. The second and third electrodes are low voltage electrodes, and the second electrode is gas permeable and separates the electrolysis zone from the discharge zone.

The following options may be used in conjunction with the first aspect, either individually or in any suitable combination.

The apparatus may comprise a fourth electrode, said fourth electrode being disposed within the discharge zone. In this instance the apparatus may be capable of generating, and/or configured to generate, a high voltage discharge between the high voltage electrode and the fourth electrode. This discharge may be within the discharge zone. The fourth electrode may be an earth electrode. It may allow passage of a gas therethrough and/or therepast. It may be porous. It may be foraminous. It may be for example a mesh electrode. In some embodiments, however, the fourth electrode is absent.

The apparatus may additionally comprise a dielectric barrier between the high voltage electrode and the discharge zone. It may coat the high voltage electrode. It may partially coat the high voltage electrode or may entirely coat it. If the fourth electrode is present, the dielectric barrier may be between the high voltage electrode and the fourth electrode. The dielectric barrier may be gas-impermeable. It may be impermeable to a gas passing through the discharge zone. It may be chemically inert thereto. In some embodiments, however, said dielectric barrier may be entirely absent.

The second electrode may be porous. It may be foraminous. It may be catalytic. It may comprise a catalytic metal. It may comprise a nanostructured metal on a gas permeable, optionally porous or foraminous, support. The support may be hydrophobic or it may be hydrophilic. The nanostructured metal may be located in and/or on a face of the second electrode abutting the electrolysis zone. It may be a catalytic metal. The nanostructured metal may be selected from the group consisting of copper, silver, nickel, titanium, gold, platinum, aluminium, tantalum, iron, ruthenium, iridium, palladium and mixtures, blends, combinations and alloys of any two or more of these. The nanostructured metal may be gas permeable, optionally porous. In some embodiments the second electrode may consist, or consist essentially, of a catalytic metal.

The electrolysis zone may contain an electrolyte in contact with both the second and third electrodes. The apparatus may be configured to allow the electrolyte to flow through the electrolysis zone or it may be configured to contain the electrolyte. The electrolyte may be a liquid electrolyte. It may be a gel electrolyte. It may be an aqueous electrolyte. It may be a solid electrolyte.

The discharge zone may contain a gas containing nitrogen.

In one embodiment there is provided an apparatus comprising a discharge zone configured to accept a gas flow therethrough, a high voltage electrode capable of generating a high voltage discharge within the discharge zone and separated from said discharge zone by a gas impermeable dielectric barrier, and an electrolysis zone bounded by a second electrode and a third electrode, said electrolysis zone comprising an aqueous electrolyte.

In another embodiment there is provided an apparatus comprising a discharge zone configured to accept a gas flow therethrough, a high voltage electrode capable of generating a high voltage discharge within the discharge zone, said high voltage electrode being entirely coated by a gas impermeable dielectric barrier, and an electrolysis zone bounded by a second electrode and a third electrode, said electrolysis zone comprising an aqueous electrolyte.

In the above two embodiments, the second and third electrodes are low voltage electrodes, and the second electrode is hydrophobic and gas permeable, and comprises a gas permeable support having a nanostructured metal on a face thereof abutting the electrolysis zone, said second electrode separating the electrolysis zone from the discharge zone.

In a second aspect of the invention there is provided a process for making ammonia comprising generating a plasma within a nitrogen containing gas in a discharge zone, transporting transient species produced within the plasma to an electrolysis zone and electrolysing the transient species within the electrolysis zone.

The following options may be used in conjunction with the second aspect, either individually or in any suitable combination.

The transient species may have lifetimes of less than about 5 seconds.

The step of transporting may comprise passing the transient species through an electrode, optionally a catalytic electrode, which separates the discharge zone from the electrolysis zone. It may comprise passing said transient species through said electrode into an electrolyte. The electrolyte may be disposed within the electrolysis zone. It may be in contact with the said electrode.

The step of electrolysing may be conducted using an electrode which comprises a nanostructured metal. This step may be conducting using a catalytic electrode. It may be conducted using an electrode comprising a nanostructured catalytic metal. It may comprise, or may be, a step of electrocatalysing, or catalytically electrolysing, the transient species within the electrolysis zone. The step of electrolysing may produce a desired product, e.g. ammonia.

In an embodiment there is provided a process for making ammonia comprising generating a plasma within a nitrogen containing gas in a discharge zone, transporting transient species having lifetimes less than about 5 seconds produced within the plasma to an electrolysis zone, and electrolysing, e.g. electrocatalysing or catalytically electrolysing, the transient species within the electrolysis zone using an electrode which comprises a nanostructured catalytic metal. The step of transporting may take less time than the lifetimes of the transient species.

In another embodiment there is provided a process for making ammonia comprising generating a plasma within a nitrogen containing gas in a discharge zone, transporting transient species produced within the plasma through a catalytic electrode to an electrolysis zone, and electrolysing, e.g. electrocatalysing or catalytically electrolysing, the transient species within the electrolysis zone. The catalytic electrode may comprise a nanostructured catalytic metal.

In a third aspect of the invention there is provided a process for making ammonia comprising providing an apparatus according to the first aspect, passing a nitrogen containing gas through the discharge zone, generating a plasma within the nitrogen containing gas in the discharge zone, passing transient species generated in the discharge zone through the second electrode into the electrolysis zone, and electrolysing, e.g. electrocatalysing or catalytically electrolysing, the transient species in the electrolysis zone so as to produce ammonia.

The process of the second or third aspects may comprise absorbing at least a part of the ammonia into an electrolyte in the electrolysis zone. It may additionally comprise recovering the ammonia from the electrolyte.

In either the second or third aspect, a pressure of the nitrogen containing gas in the discharge zone may be sufficient to transport the transient species produced within the plasma to the electrolysis zone. It may be sufficient to transport the transient species produced within the plasma to the electrolysis zone in a time shorter than the lifetime of the transient species. The electrolysis zone may contain an aqueous electrolyte.

In either the second or third aspect, the step of transporting may take less time than the lifetimes of the transient species.

### BRIEF DESCRIPTION OF THE DRAWINGS

Certain embodiments of the present invention will now be described, by way of example only, with reference to the accompanying figures, wherein:

FIGS. 1A-B show, in FIG. 1A, a scheme perspective of sustainable ammonia production: Gen 1: Haber-Bosch Process using pure H₂ and N₂ from dry reforming and air separation; Gen 2: Green Haber-Bosch Process using hydrogen evolution reaction (HER) from electrolysis; Gen 3: Direct Plasma-Electrolysis Process applying sustainable energy and feedstock resources. FIG. 1B shows electrolysis routes towards NH₃ from N₂, NOₓ, and ionic NOₓ compounds (vs. standard hydrogen electrode) and representative metal catalysts. Ammonia from N₂ direct reduction requires the transfer of 3 electrons and theoretical voltage at 0.056 V (versus Standard Hydrogen Electrode, SHE). Ammonia from a NO₃⁻ pathway requires the transfer of 8 electrons and theoretical voltage at 0.70 V (vs. SHE). The left-hand scale represents the Commercial Readiness Index: see Commercial Readiness Index for Renewal Energy Sectors, available at https://arena.gov.au/assets/2014/02/Commercial-Readiness-Index.pdf.

FIG. 2 shows a comparison of state-of-art NRR processes.

FIGS. 3A-G show schematics of the plasma-electrolysis process: (A) Liquid-electrolyte batch hybrid-plasma-electrolysis-system (HPES); (B) Liquid-electrolyte continuous HPES; (C) One-sided continuous HPES; (D) Double-sided gas diffusion continuous HPES; (E) Gas-generated continuous HPES; (F) Solid-electrolyte continuous HPES; (G) Double-sided solid-electrolyte continuous HPES.

FIG. 4 shows plasma-electrocatalysis performance with N₂ as the feed gas.

FIG. 5 shows plasma-electrocatalysis performance with air as the feed gas.

FIG. 6 shows a diagrammatic sectional view of an apparatus according to the invention.

FIG. 7 shows a schematic of an apparatus according to the present invention.

FIGS. 8A-B show graphs of results of a plasma-electrolysis ON-OFF experiments: (A) the concentration of NH₄⁺ in the catholyte (Nessler's Reagent method); (B) current and integrated charge of the working electrode.

### KEY TO FIGURES

In the figures, the following numberings apply.
10: electrochemical station
20: plasma power station
30: gas inlet
40: gas outlet
50: electrolyte
60: product outlet
70: pump
80: mass flow controller
90: gas
100: counter electrode
110: ion exchange membrane
120: catalyst
130: gas diffusion layer
140: plasma
150: solid electrolyte
160: screw
170: current collector
180: 3rd electrode
190: electrolysis chamber (counter electrode)
200: ion exchange membrane
210: electrolysis chamber (working electrode)
220: 2nd electrode (working electrode)
230: 4th electrode (ground)
240: dielectric barrier
250: 1st electrode (high voltage)
260: plasma chamber

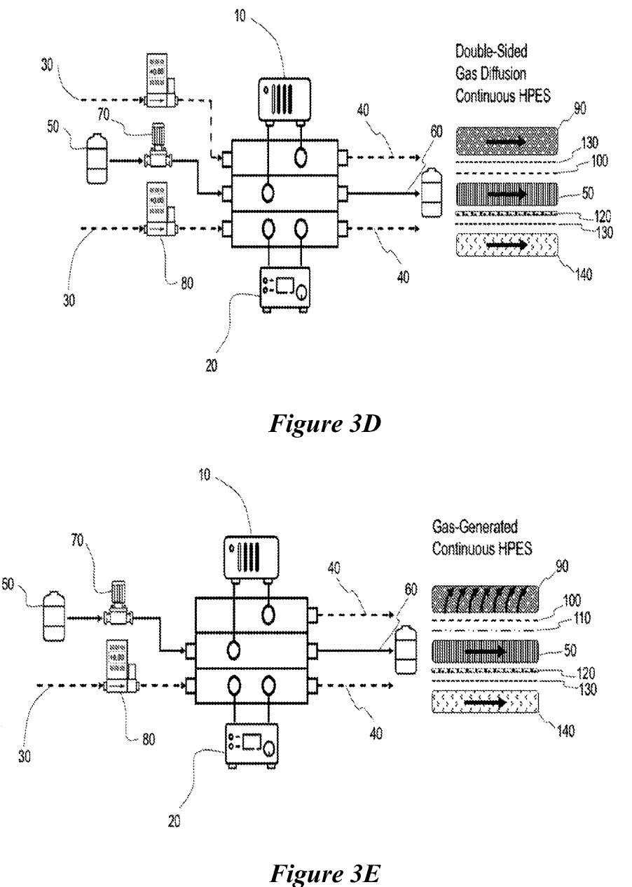

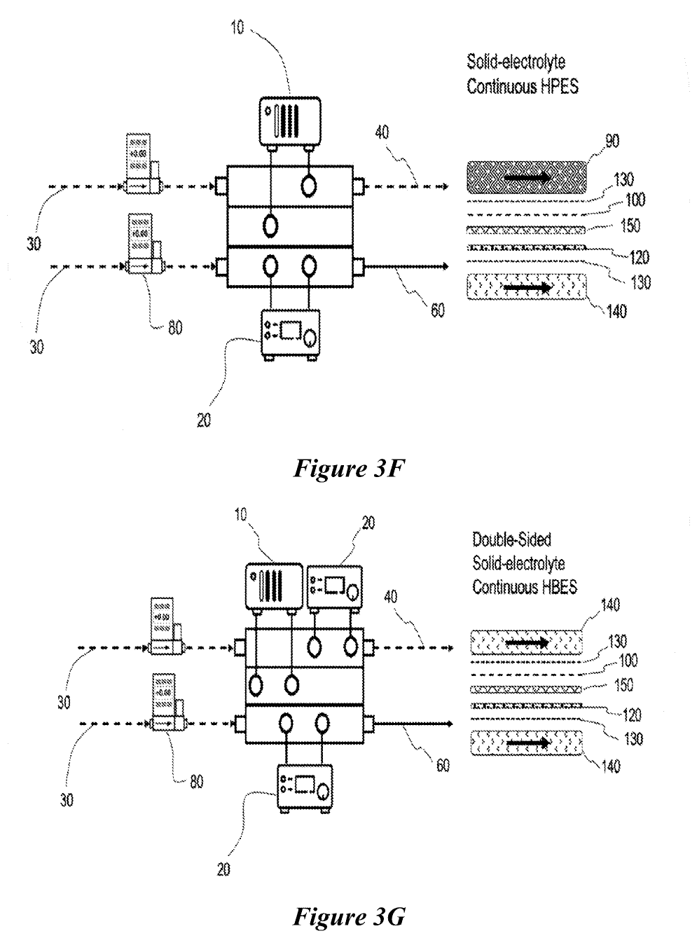

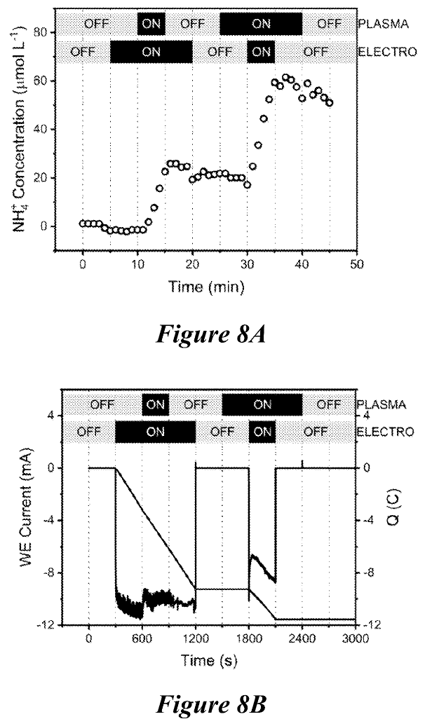

Note: in FIGS. 4 and 5, the bars refer to the left hand scale (catalyst performance) and the lines/square data points refer to the right hand scale (energy efficiency). In FIG. 8B, the line comprising the first horizontal segment, the two diagonal segments and the two lower horizontal segments refer to the right hand scale (Q (C)) and the remaining segments refer to the left hand scale (WE current).

### DETAILED DESCRIPTION

As used herein, the term “comprising” means “including”. Variations of the word “comprising”, such as “comprise” and “comprises”, have correspondingly varied meanings. As used herein, the terms “including” and “comprising” are non-exclusive and allow for the presence of other integers, optionally unspecified. As used herein, the terms “including” and “comprising” do not imply that the specified integer(s) represent a major part of the whole. The term “consists essentially of” means that the specified integers are the only integers intentionally present, although other integers, generally minor, may incidentally be present. The term “consists of” means that the specified integers are the only integers present. Where any word or phrase is defined, any other part of speech or other grammatical form of that word or phrase has a cognate meaning.

The use of the terms “a” and “an” and “the” and similar referents in the context of describing the invention (especially in the context of the claims) are to be construed to cover both the singular and the plural, unless otherwise indicated herein or clearly contradicted by context.

The term “may” as used herein encompasses both positive and negative options. Thus, for example, the phrase “A may be B” encompasses the alternatives “A is B” and “A is not B”.

The term “transient species” refers to a species having a short half-life. It may have a half-life at room temperature of less than about 1 minute, or less than about 30, 20, 10, 5, 2 or 1 second(s).

### DETAILED DESCRIPTION

The present invention relates to a hybrid plasma-electrocatalytic system (HPES) which enables activation of inert gaseous small molecules and a subsequent electrolysis, commonly electrocatalysis, step. This combined process is suitable for green chemistry production. The production rate and energy efficiency of the process can be greatly boosted by judicious choice of operating parameters. Operating parameters that may be adjusted include the flow rate of gas through the discharge zone, the flow rate of electrolyte through the electrolysis zone, the pressure of gas in the discharge zone, the pressure difference across the second electrode, the potential applied to the high voltage electrode and the frequency of that potential, the potential applied between the second and third electrodes etc. It will be recognized that certain of these parameters may be at least partially interdependent. For example, the pressure difference across the second electrode may depend in part on the pressure of the gas in the discharge zone. It will also be recognized that certain of these parameters will depend on the scale of the apparatus. Thus, for example, a larger apparatus, designed to generate a higher rate of production, may operate with a higher flow rate of gas through the discharge zone. Adjustment of these parameters in order to produce a usable process is a matter of routine for the skilled person.

An aspect of the present invention is that gaseous plasma derived species may contact a catalytic material within and/or at the boundary of the electrolysis zone. It is thought that in at least some instances these plasma derived species interact with and/or bind to a catalytic material at or near the boundary of the electrolysis zone and that this interaction/binding may facilitate the electrolysis of the plasma derived species so as to produce desired products such as ammonia. Thus the plasma derived species can move rapidly from the discharge zone to the electrolysis zone where they can be electrocatalysed to form the desired products. They move to the electrolysis zone sufficiently rapidly that they do not substantially degrade and/or decay and/or convert to a more stable species.

Previously, products from plasma conversion of nitrogen-containing gases have been converted to ammonia using electrocatalysis. However, the process and apparatus used to achieve that ensured that only long-lived and relatively stable plasma derived products such as nitrate and nitrite were subjected to electrocatalysis. This was because the site of electrolysis was remote from the plasma generation site, so that there was considerable time taken for plasma derived products to pass to the site of electrolysis. Accordingly, the energy released as the initial transient plasma derived products decayed to those more stable products was lost in the process, possibly in the form of heat, electromagnetic radiation (e.g. uv, visible light or infrared) or some other form of emission. The inventors have surprisingly found that these initially formed transient species can be electrocatalysed using the apparatus described herein. This avoids the energy loss associated with decay to more stable products, resulting in a more efficient process. The table below describes the excitation energy of different states of N₂.

| | | | |
|---|---|---|---|
| N₂ ionization | N₂ ↔ N₂⁺ | 15.60 | eV |
| N₂ sum of singlet states | N₂ ↔ N₂(sum) | 13.00 | eV |
| N₂ electronic (a″1) excitation | N₂ ↔ N₂(a″1) | 12.25 | eV |
| N₂ electronic (E3) excitation | N₂ ↔ N₂(E3) | 11.87 | eV |
| N₂ electronic (C3) excitation | N₂ ↔ N₂(C3) | 11.03 | eV |
| N₂ electronic (w1) excitation | N₂ ↔ N₂(w1) | 8.89 | eV |
| N₂ electronic (a1) excitation | N₂ ↔ N₂(a1) | 8.55 | eV |
| N₂ electronic (a′1) excitation | N₂ ↔ N₂(a′1) | 8.40 | eV |
| N₂ electronic (B′3) excitation | N₂ ↔ N₂(B′3) | 8.16 | eV |
| N₂ electronic (A3 V = 10−) | N₂ ↔ N₂(A3 v = 10−) | 7.80 | eV |
| excitation | | | |
| N₂ electronic (W3) excitation | N₂ ↔ N₂(W3) | 7.36 | eV |
| N₂ electronic (B3) excitation | N₂ ↔ N₂(B3) | 7.35 | eV |
| N₂ electronic (A3 V = 5 − 9) | N₂ ↔ N₂(A3 v5 − 9) | 7.00 | eV |
| excitation | | | |
| N₂ electronic (A3 V = 0 − 4) | N₂ ↔ N₂(A3 v0 − 4) | 6.17 | eV |
| excitation | | | |
| N₂ vibrational (V = 8) excitation | N₂ ↔ N₂(v8) | 2.35 | eV |
| N₂ vibrational (V = 7) excitation | N₂ ↔ N₂(v7) | 2.06 | eV |
| N₂ vibrational (V = 6) excitation | N₂ ↔ N₂(v6) | 1.76 | eV |
| N₂ vibrational (V = 5) excitation | N₂ ↔ N₂(v5) | 1.47 | eV |
| N₂ vibrational (V = 4) excitation | N₂ ↔ N₂(v4) | 1.17 | eV |
| N₂ vibrational (V = 3) excitation | N₂ ↔ N₂(v3) | 0.88 | eV |
| N₂ vibrational (V = 2) excitation | N₂ ↔ N₂(v2) | 0.59 | eV |
| N₂ vibrational (V = 1) excitation | N₂ ↔ N₂(v1) | 0.29 | eV |
| N₂ rotational excitation | N₂ ↔ N₂(rot) | 0.02 | eV |
| N₂ ground state | N₂(X) | 0.0 | V |

The presently described novel hybrid process combines advanced non-thermal plasma technology and smart nano-catalyst designs to stimulate the reaction process through a scalable and green-energy feasible new membrane electrode assembly (MEA). The invention involves both system and catalyst design, where the electrochemical nitrogen reduction process is investigated as an example. The process is however applicable to other electrochemical systems. For example, in order to produce ammonia, the second electrode should be the cathode, however to promote oxidation so as to provide oxidized nitrogen species such as nitrate and nitrite, the second electrode should be the anode.

The well-established Haber-Bosch Process has supplied global nitrogen fertilizer for a century. It generates the majority of artificial nitrogen fixation and supports growing global population. However, the H-B process faces challenges of scaling-down and fixing into sustainable energy grid to be suitable for decentralized green ammonia production.

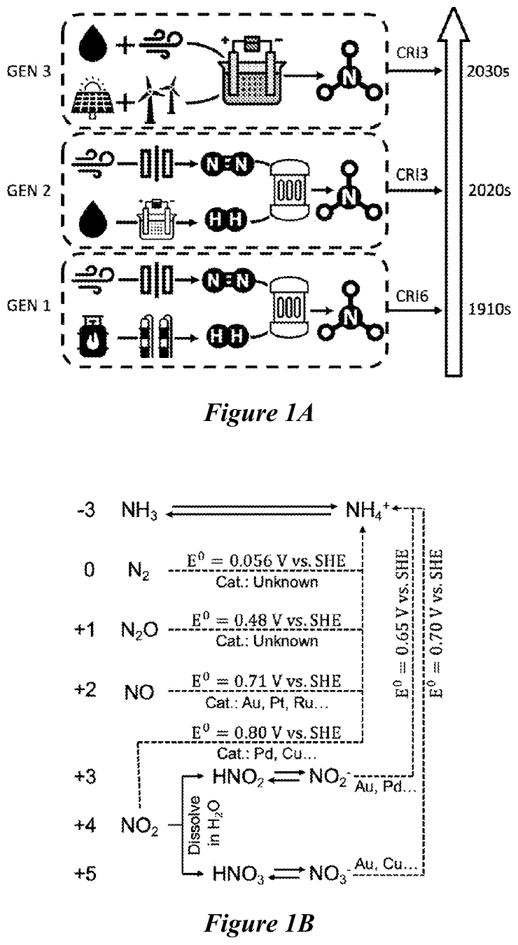

FIG. 1A shows the evolution of ammonia production processes, from the original Haber-Bosch process in the early 20^{th} century to the present process. Thus, the original Haber-Bosch process (Gen. 1) used nitrogen, obtained separation from air, together with hydrogen, obtained from industrial processes, to produce ammonia. In the early 21^{st} century more sophisticated versions of this process were developed (Gen. 2) using hydrogen derived from electrolysis. This enabled use of renewable energy sources such as solar energy to obtain the hydrogen. However, this process still suffered from problems of down-scalability. The present process is represented as Gen. 3. This process is capable of using atmospheric air as the source of nitrogen, and using renewable sources of energy to provide a down-scalable and much more versatile and environmentally friendly source of ammonia.

FIG. 1B shows electrocatalytic processes for generating ammonia or ammonium from nitrogen and from oxides of nitrogen. As indicated, various catalysts have been used for these conversions, although at this time it is not known what catalysts could facilitate the electrocatalytic conversion of nitrogen or nitrous oxide to ammonia in the absence of external activation. The present invention may provide this activation by way of a plasma.

Electrochemical nitrogen reduction reactions (eNRRs) as competitive alternatives to the Haber-Bosch process show the potential of developing decentralized chemical plants and utilizing energy from sustainable sources. However, efficient eNRR still suffers from some challenges to meet the scale-up nitrogen fixation, due to the fact that nitrogen (N₂) is a non-polarizable and extremely stable molecule. This challenge can be tackled, as described herein, by introducing the non-thermal plasma to produce activated gas compounds at ambient conditions, which provides a unique pathway for targeting the desired chemical reactions. The combined strategy of plasma-electrolysis can be adapted to other reaction systems.

The emerging P2X strategy provide a promising future to take advantage of enormous and remote sustainable energy to green fuels. The decentralized production sites can also support local agricultural and industrial development. P2X refers herein to processes that convert renewable energy into fuels and/or useful chemicals.

Direct eNRR under ambient conditions has long been desired because of the potential low energy cost and high feasibility to green power-grid. However, to date it has been limited by low catalytic activity and production rate, as well as poor reliability. The Li-intermediate eNRR approach relies on the forming of lithium nitride (Li₃N), however, this commonly uses ethanol as proton donor. This is not expected to regenerate at the anode. Plasma NRR may be applied using water as a sustainable proton source, but the high energy consumption has limited its practical use. The inventors have now found that plasma-assisted eNRR, described herein, can combine technical features of both plasma and electrolysis, providing reactive species for activation, meanwhile, maintaining acceptable energy efficiency.

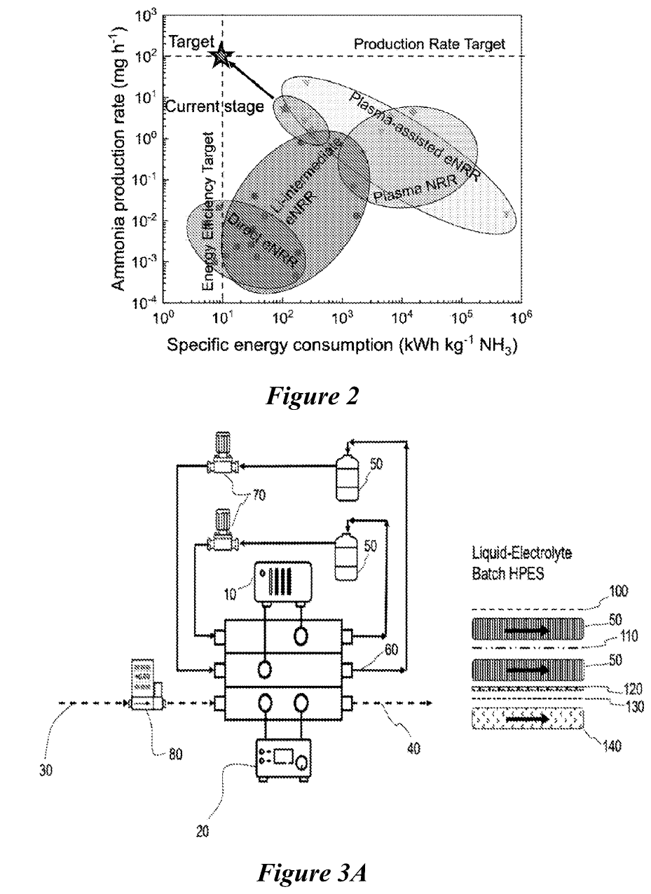

FIG. 2 shows the energy efficiencies of different NRR processes for production of ammonia. Thus direct eNRR is capable of providing acceptable energy efficiency, in some instances below the target of 10 KWh/kgNH₃. However it suffers from very low production rates. Other processes, either using lithium intermediates or plasma assistance, provide higher production rates, in some instances approaching the desired rate of about 100 mg/h. However these are unacceptably energy intensive. The present process (labelled “current stage” in FIG. 2) provides both high energy efficiency and high production rates. It is expected that improvements in production parameters and apparatus will result in a process and apparatus capable of meeting both energy efficiency and production rate targets.

As discussed earlier herein, the apparatus of the invention comprises a discharge zone and a high voltage electrode capable of generating a discharge in the discharge zone so as to produce a plasma. The discharge zone may be configured for generation of a plasma. Thus a discharge generated by the high voltage electrode, in operation of the apparatus, generates a plasma within the discharge zone. The plasma generated within the discharge zone may be a nonthermal plasma. It may be mixed with a gas in the discharge zone, i.e. the gas may be only partially ionized to plasma. The high voltage electrode may be shielded from the discharge zone by a dielectric barrier. It may be entirely coated, or partially coated, by a dielectric barrier. A suitable dielectric barrier may be for example glass, quartz, alumina, silica, titania or a mixed oxide of two or all of aluminium, silicon and titanium. If a dielectric barrier is present, then the discharge zone may be between, optionally bounded by, the dielectric barrier and the second electrode. The dielectric barrier and the second electrode may define the discharge barrier therebetween. The dielectric barrier may serve to protect the high voltage electrode from plasma generated in the discharge zone. Alternatively, in some embodiments there may be no dielectric barrier shielding the high voltage electrode from the discharge zone. In such embodiments, the discharge zone may be between, optionally bounded by, the high voltage electrode and the second electrode.

Thus the high voltage electrode may be located within the discharge zone or may form one boundary of the discharge zone or may be separated from the discharge zone by the dielectric barrier which forms one boundary of the discharge zone. The apparatus may be configured to apply a voltage of from about 1 to about 50 kV within the discharge zone. It may be so configured by comprising a source of the high voltage. Suitable sources include batteries, turbines, generators etc., optionally in combination with a transformer. Such sources are well known to those skilled in the art. In operation the voltage applied to the high voltage electrode may be from about 1 to about 50 kV, as detailed elsewhere herein. The source of high voltage may be electrically connected to the high voltage electrode.

The fourth electrode, if present, may be an earth electrode. It may be gas permeable. It may be permeable to a plasma generated within the discharge zone. It may be in the form of a mesh. It may be a mesh electrode. It may have a hole diameter of from about 1 to about 20 mm, or about 1 to 10, 1 to 5, 1 to 2, 2 to 20, 5 to 20, 10 to 20, 2 to 10 or 5 to 10 mm, e.g. about 1, 2, 3, 4, 5, 6, 7, 8, 9, 10, 11, 12, 13, 14, 15, 16, 17, 18, 19 or 20 mm. This large hole diameter facilitates ready passage of transient plasma-derived species from the discharge zone to the electrolysis zone. In some instances the mesh electrode may be the high voltage electrode. In some embodiments the fourth electrode is not gas permeable but is disposed so as to allow passage of the transient plasma-derived species therepast so as to allow them to pass to the second electrode.

In the absence of the fourth electrode, the voltage within the discharge zone may be between the high voltage electrode and the environment, e.g. the air or some other portion of the apparatus.

The discharge zone preferably has a constant thickness (i.e. distance between the high voltage electrode, or the dielectric barrier if present, and the second electrode. There are various geometries that may be employed in order to achieve this. For example both the high voltage electrode and the second electrode, and, if present, the dielectric barrier, may be planar. They may be parallel. Alternatively they may be concentric, whereby the discharge zone has an annular cross section, with the high voltage electrode at the centre, or core, of the annulus and surrounded by the second electrode. Other geometries may also be used.

The discharge zone is configured to accept a gas flow therethrough. Thus it may be connected to (or connectable to) a source of the gas. It may comprise a gas inlet. It may comprise a gas outlet to allow the gas to flow out of the discharge zone. The gas outlet may be constrictable, e.g. by means of a valve, so as to ensure that, in operation, some of the gas flows through the second electrode to the electrolysis zone. Alternatively, there may be no gas outlet, whereby all of the gas, together with plasma formed in the discharge zone, passes into the electrolysis zone. The gas and plasma may pass through the second electrode to the electrolysis zone. The gas inlet may have a regulator to control the flow of gas into the discharge zone.

In operation, a mixture of gas and plasma generated in the discharge zone passes through the second electrode. Therefore the second electrode may be permeable to the gas/plasma mixture. It may be porous. It may have a mean pore diameter of from about 0.1 to about 100 mm, or from about 0.1 to 50, 0.1 to 10, 0.1 to 5, 0.1 to 2, 0.1 to 1, 0.1 to 0.5, 0.5 to 100, 1 to 100, 10 to 100, 50 to 100, 0.5 to 10, 0.5 to 5, 0.5 to 2 or 1 to 10 mm, e.g. about 0.1, 0.2, 0.3, 0.4, 0.5, 1, 1.5, 2, 2.5, 3, 3.5, 4, 4.5, 5, 6, 7, 8, 9, 10, 15, 20, 25, 30, 35, 40, 45, 50, 60, 70, 80, 90 or 100 mm.

The second electrode may comprise, or consist of, or consist essentially of, a catalytic metal or it may comprise, or consist of, or consist essentially of, a catalytic non-metal e.g. carbon. It may comprise, or consist of, or consist essentially of, a combination of catalytic metal and catalytic non-metal. This facilitates electrolysis of the transient species in the plasma to form product. The catalytic metal and/or catalytic non-metal may be nanostructured. It may be in the form of nanoparticles, nanowires, nanofibers, nanotubes, a nanoporous sheet or in other suitable form. The nanowires, nanofibers or nanotubes may be in the form of long continuous fibres or in the form of short fibres to form a fibrous mat. The diameter of the nanoparticles, or of the nanowires, may be from about 1 to about 100 nm, or about 1 to 50 nm 1 to 20, 1 to 10, 10 to 100, 20 to 100, 50 to 100, 10 to 50 or 20 to 50 nm, e.g. about 1, 2, 3, 4, 5, 10, 15, 20, 25, 30, 35, 40, 45, 50, 60, 70, 80, 90 or 100 nm. The nanoparticles may be self-supporting (particularly in the case of nanowires) or they may be supported on a gas-permeable support (also referred to herein as a gas diffusion layer). The support may be porous. It may have a mean pore diameter of from about 1 to about 1000 mm, or from about 1 to 500, 1 to 200, 1 to 100, 1 to 50, 1 to 20, 1 to 10, 10 to 1000, 20 to 1000, 50 to 1000, 100 to 1000, 500 to 1000, 100 to 500, 10 to 100 or 100 to 500 mm, e.g. about 1, 2, 3, 4, 5, 10, 15, 20, 25, 30, 35, 40, 45, 50, 60, 70, 80, 90, 100, 150, 200, 250, 300, 350, 400, 450, 500, 600, 700, 800, 900 or 1000 mm. In some instances there are only a few holes in the support (in the extreme, only one), to allow the plasma to penetrate into the electrolysis zone. In the event that the second electrode comprises a catalyst on a support, the catalyst may be on the face of the electrode adjoining the electrolysis zone, or it may be at least partially embedded in that face. It may be on the face of the support away from the discharge zone, or it may be at least partially embedded in that face. The second electrode may be such that it prevents passage of electrolyte but permits passage of gas/plasma into the electrolysis zone.

As described elsewhere herein, the electrolysis zone, which is bounded on one side by the second electrode, may comprise an electrolyte. The second electrode may be impermeable to the electrolyte. In the event that the electrolyte is hydrophilic, the second electrode, or at least the support, may be hydrophobic. The support may be a ceramic. It may be a porous ceramic. It may be a hydrophobic porous ceramic. It may comprise hydrophobic alumina, silica, titania or a hydrophobic mixed oxide of two or all of aluminium, silicon and titanium. It may be some other porous material. It may be carbon, e.g. a carbon mat, glass, quartz, plastic (e.g. PEEK, PTFE, polyethylene or other polymeric material).

The second electrode separates the discharge zone from the electrolysis zone. It is therefore disposed between the discharge zone and the electrolysis zone. The second electrode forms one boundary of the discharge zone and also forms one boundary of the electrolysis zone.

The second and third electrodes are low voltage electrodes. Thus they are connected to, or connectable to, a source of low voltage. This may be for example a battery capable of producing the electrolysis voltage described elsewhere herein.

If present, the electrolyte may be a liquid electrolyte, a solid electrolyte or a gel electrolyte. It may be aqueous. It may be an aqueous liquid or it may be an aqueous gel. It may be a non-aqueous electrolyte. It may comprise an organic liquid. It may be an ionic liquid. It may be protic. It may comprise a source of hydrogen. It may be a salt solution. The salt may be a sodium or potassium salt or some other salt. It may be a sulphate or nitrate or halide or some other salt. It may be neutral pH or it may be acidic. The salt may be present from about 0.01 to about 10M, or about 0.1 to 10, 1 to 10, 1 to 5, 0.5 to 2, 1 to 2, 0.1 to 0.5 or 0.5 to 1M, e.g. about 0.01. 0.05, 0.1, 0.2, 0.3, 0.4, 0.5, 0.6, 0.7, 0.8, 0.9, 1, 1.2, 1.4, 1.6, 1.8, 2, 3, 4, 5, 6, 7, 8, 9 or 10M.

Solid electrolytes, also known as proton conductors, include, for example polymer electrolytes, metal oxide electrolytes, ceramic electrolytes, alkaline-earth cerates and zirconate based perovskite electrolytes, etc.

The electrolysis zone may be configured to allow the electrolyte to flow through the zone, or may be configured such that the electrolyte is static within the zone. In the former case, the product(s) of electrolysis may at least partially dissolve in the electrolyte and may pass out of the electrolysis zone as a solution. In some cases, there may be a separator for separating one or more products from the electrolyte. The electrolyte may then be returned to the electrolysis zone. This may therefore form a closed loop. In the latter case, the product may build up in the electrolysis zone to the extent that it separates from the electrolyte. This may allow it to be removed from the electrolysis zone without removing the electrolyte from the electrolysis zone.

In some instances, the electrolysis zone is separated into a catholyte zone and an anolyte zone. These may be separated by an ion exchange membrane. This may for example be cation-exchange membrane (e.g., Nafion®), anion-exchange membrane (e.g., Sustainion®), or bipolar membrane (Xion®). In this case, the anolyte and catholyte (i.e. the electrolytes in the anolyte zone and catholyte zone respectively) may each, independently, be as described above. They may be the same or they may be different. Thus the electrolysis zone may comprise two half-cells. These may be connected by an ion bridge. They may be separated by an ion exchange membrane. The electrolysis zone may comprise an inlet and an outlet to allow electrolyte to flow through the electrolysis zone. In the event that the electrolysis zone comprises two half-cells, each may have an inlet and an outlet to allow electrolyte to flow through the half cells. In some embodiments one or both of the half-cells has only an inlet, in order to allow electrolyte to be inserted into the half-cell(s).

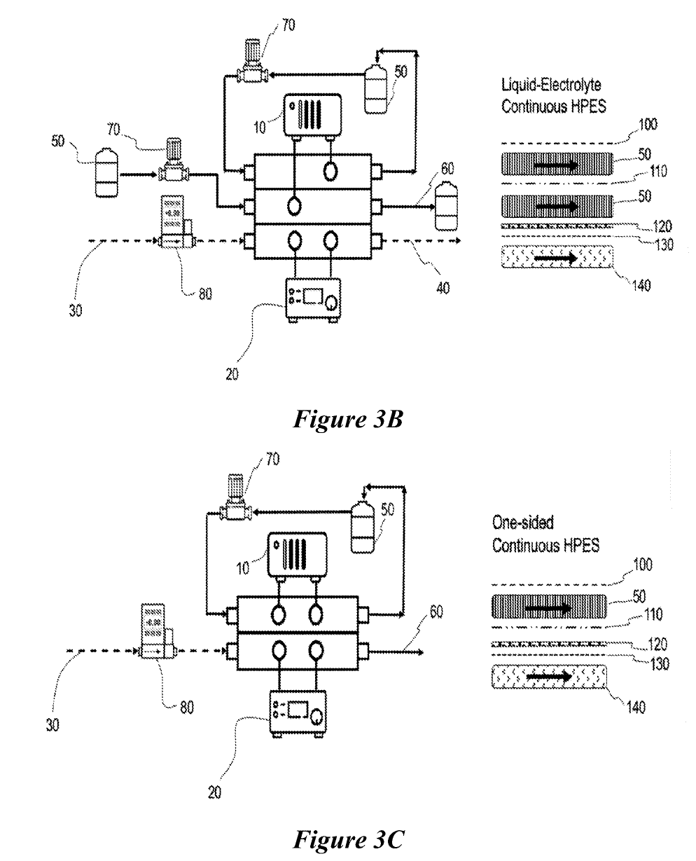

Various options for the apparatus of the present invention are shown diagrammatically in FIGS. 3A-G. Diagram A shows a liquid-electrolyte batch HPES which comprises a discharge zone and an electrolysis zone comprising a cathode chamber and an anode chamber. In operation, gas flows through discharge zone and is activated by a plasma discharge. This activated gas (containing plasma) then passes through catalyst-loaded gas diffusion layer and is subjected to an electrolysis process to generate product. This product exits the electrolysis zone in the electrolyte and accumulates to a certain concentration. Diagram B shows a liquid-electrolyte continuous HPES which has a similar structure to that of the liquid-electrolyte batch HPES of (A). In this design, electrolyte continuously flows through electrolysis chamber, and leaves at a desired product concentration. In the present application the focus is on N₂ reduction. Therefore the focus is primarily on the cathode and catholyte (and therefore generally the cathode is the working electrode). It is also possible to apply a positive potential in order to activate N₂ for oxidation to oxidative NOₓ products (in which case, the working electrode would be the anode). Diagram C shows a one-sided continuous HPES which has no electrolyte passing through the working electrode (second electrode), in which product will mainly stay in gaseous form. In this case the chamber connected to the plasma power station is the discharge chamber. There is only a single electrolyte stream, which passes the counter electrode. The electrolyte is not in direct contact with the working (second) electrode, but the ion exchange membrane allows electrolyte to penetrate to the working electrode. Electrocatalysis occurs on the working electrode (labelled “catalyst”). Product cannot pass through the ion exchange membrane and will either remain at the catalyst/gas diffusion electrode or, primarily leave in the flowing gas. Diagram D shows a double-sided gas diffusion continuous HPES enables the gas diffusion at both cathode and anode sides. In this diagram the counter electrode reaction requires a different gas flow. In contrast to FIGS. 3A, B and C and in the examples, nickel foam was used as the anode for the Oxygen Evolution Reaction (OER), meaning that the counter reaction generates oxygen from water. Thus in this case, the counter electrode reaction also consumed gas. This could, for example, be a hydrogen oxidation reaction, methane oxidation reaction, etc. In some cases, there may be a sacrificial reaction on counter electrode, which does not generate product, but does consume some reactant. The benefit in this may be to lower the potential needed to be applied on cathode. Sometimes, it also can generate product, for example, from methane to methanol (oxidative product). Diagram E shows a gas-generated continuous HPES having an ion-exchange membrane at the counter-electrode so as to prevent undesired oxidation/reduction of product. The main difference in FIG. 3E is that this design can allow collection of gas generated from the counter electrode split from counter electrolyte. Reactant can pass through the ion-exchange membrane to reach the counter electrode. For example, for OER, OH⁻ can pass through the anion-exchange membrane to reach the catalyst (e.g. Ni foam, Fe mesh, or IrO₂, or RuO₂), then oxidize to O₂, then leave in gaseous form. This design allows for the working electrolyte, where product will leave, to be aqueous. Diagram F shows a solid-electrolyte continuous HPES which uses a solid-electrolyte to conduct current and reactant. This allows the whole system to operate at over 100° C. In this instance, the solid electrolyte serves to transfer reactant—the product would not remain in the electrolyte or the membrane. By suitable design and engineering the membrane or solid electrolyte, it is possible to ensure that specific species can migrate whilst others cannot. In the present design, reactant can be excited, oxidized and then transferred to the working electrodes where it can react with excited gases on the working electrolyte. The solid electrolyte may be substituted by an aqueous electrolyte. It should also be noted that a solid electrolyte may permit passage of certain liquids. Diagram G shows a double-sided solid-electrolyte continuous HBES which has two plasma zones, one on either side of the electrolysis zone. Thus each side of the electrolysis zone is gas permeable, allowing plasma to enter from both sides. In this arrangement, product is generated in the central electrolysis zone and passes into the gas flow through the lower discharge zone, where it passes out of the apparatus in the gas flow.

As described, the electrolyte may be a liquid (optionally aqueous) electrolyte, an ion exchange membrane, a proton conductor or a solid electrolyte. The electrolysis zone may be a single zone or may be subdivided into anolyte and catholyte zones. The electrolyte zone may be static (batch) or flow-through (continuous). There may be liquid or gas flow through solid electrolyte. There may be one discharge (plasma) zone or may be two, one on each side of the electrolysis zone.

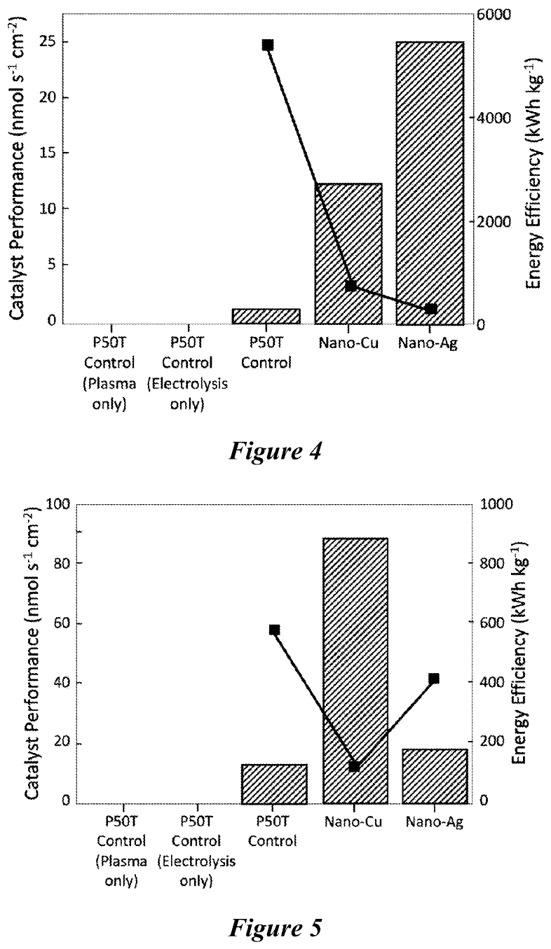

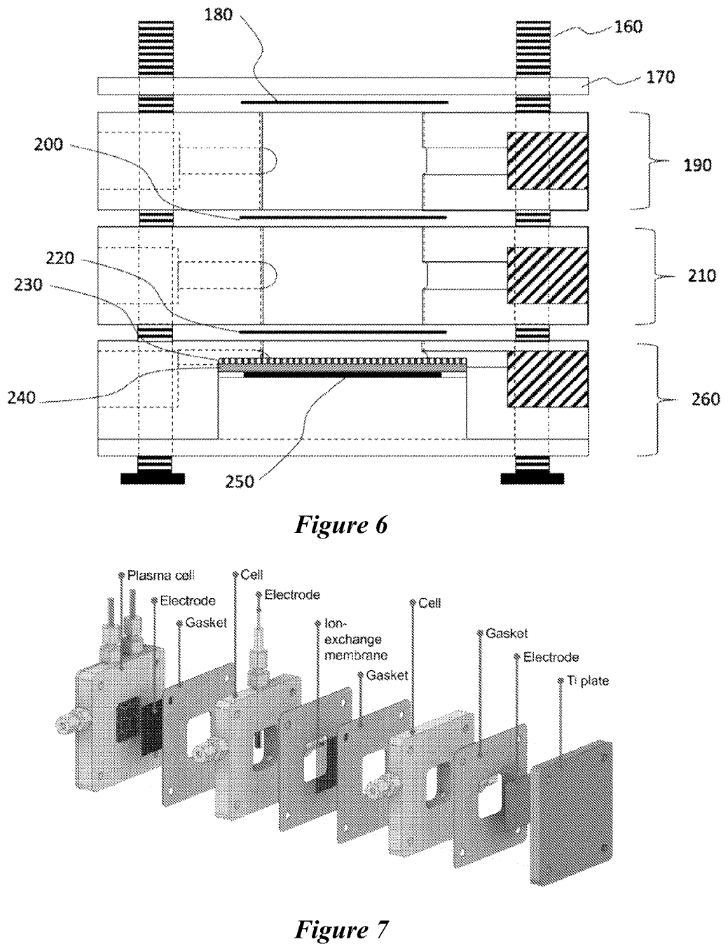

FIG. 6 shows a schematic of an apparatus according to the present invention. Thus the high voltage electrode is separated from the gas flow by a dielectric barrier. A fourth (ground) electrode is provided so that, in use, a high voltage generated between the high voltage electrode and the ground electrode generates a plasma in the inflowing gas between the dielectric barrier and the ground electrode. The dielectric barrier prevents this plasma from damaging the high voltage electrode. The ground (earth) electrode is in the form of a mesh, allowing the gas/plasma mix to pass to the second electrode. The second electrode separates the discharge zone from the electrolysis zone. The second electrode is porous, allowing the gas/plasma mixture to pass through it into the lower portion of the electrolysis chamber. The electrolysis chamber is divided into two half-cells: a lower half-cell bounded by the second electrode and an ion-exchange membrane and an upper half-cell bounded by the ion-exchange membrane and the third electrode. FIG. 7 shows a similar apparatus to that of FIG. 6, with the various components separated for easy visualization. In FIG. 7 the plasma cell contains two plasma electrodes for generating a gas within the discharge zone. It is also fitted with a gas inlet which, in operation, is connected to a source of a gas containing nitrogen. A gas permeable electrode separates the discharge zone from an electrolysis zone and a gasket is provided to seal the plasma cell to a first half-cell fitted with a reference electrode. Two further gaskets with an ion exchange membrane between them are provided to separate the first half-cell to a second half cell. The second half cell is fitted with a gasket and a plate electrode, with a titanium plate for enclosing the second half cell. Each of the half-cells is fitted with an inlet and an outlet to allow electrolyte to pass into and out of (i.e. through) the half-cell and the first half-cell is fitted with a reference electrode. In operation, a high voltage is applied between the plasma electrodes while a gas containing nitrogen is passed into the cell so as to generate a plasma in the gas. This plasma contains highly reactive nitrogen species which pass through the gas permeable electrode into the first half-cell. A low voltage is applied between the gas permeable electrode and the electrode in in the second half-cell so as to generate ammonia from the reactive species. The ammonia can exit the apparatus through the outlet in the half-cell in which it is generated and may be isolated from the stream of electrolyte.

In a particular example of the apparatus shown in FIGS. 6 and 7, the second electrode comprises a nano-structured catalytic metal on a porous support. In operation, plasma-derived transient species pass through the second catalyst and are electrocatalysed at the catalyst surface. The design allows for short-lived or transient plasma species (ns-s) to reacts with the catalyst and electrolyte. The product ammonia will leave primarily in the electrolyte, which is aqueous and therefore has the ability to dissolve large amounts of product, although some may also leave in the gas flow.

The following operating parameters may be used in the present invention, however the skilled person will recognise that values outside these ranges may be used in certain circumstances:
Pressure within the discharge zone: about 1 to about 5 atmospheres, or about 1 to 3, 1 to 2, 1 to 1.5, 2 to 5, 3 to 5, 3 to 5 or 2 to 4, e.g. about 1, 1.1, 1.2, 1.3, 1.4, 1.5, 2, 2.5, 3, 3.5, 4, 4.5 or 5 atmospheres.
Temperature in the electrolysis zone: about 0° to about 95° C., or about 0 to 50, 1 to 20, 20 to 95, 50 to 95, 15 to 80, 15 to 50, 15 to 30, 20 to 50 or 30 to 70° C., e.g. about 0, 5, 10, 15, 20, 25, 30, 35, 40, 45, 50, 55, 60, 65, 70, 75, 80, 85, 90 or 95° C. In the case of non-aqueous electrolytes, higher temperatures may be used, e.g. 100° C. to 600° C., 100 to 300, 100 to 200, 200 to 600, 300 to 600, 200 to 400 or 100 to 150° C., e.g. about 100, 150, 200, 250, 300, 350, 400, 450, 500, 550 or 600° C.
Plasma discharge voltage (i.e. the potential applied to the high voltage electrode): about 1 to about 50 kV, or about 1 to 5, 1 to 2, 2 to 10, 5 to 10, 10 to 50, 10 to 20, 20 to 50 or 3 to 7 kV, e.g. about 1, 2, 3, 4, 5, 6, 7, 8, 9, 10, 15, 20, 25, 30, 35, 40, 45 or 50 kV.
Plasma discharge peak current: about 10 mA to about 10 A, or about 10 to 1000 mA, 10 to 100 mA, 100 to 1000 mA, 1 to 10, 2 to 8, 2 to 6, 2 to 4, 4 to 10, 6 to 10 or 4 to 8 A, e.g. about 10, 20, 30, 40, 50, 100, 200, 300, 400 or 500 mA, or 1, 2, 3, 4, 5, 6, 7, 8, 9 or 10 A.
High voltage frequency: AC power frequency range from about 5 kHz to about 20 kHz, or about 7 to 20, 10 to 20, 150 to 20, 5 to 10 or 7 to 15 kHz, e.g. about 5, 6, 7, 8, 9, 10, 11, 12, 13, 14, 15, 16, 17, 18, 19 or 20 kHz. Nano-pulsed power frequency range from about 1 Hz to about 10 kHz, or about 1 to 5, 1 to 2, 2 to 10, 5 to 10 or 3 to 7 kHz, e.g. about 1, 2, 3, 4, 5, 6, 7, 8, 9 or 10 kHz. AC modulated pulsed power frequency range from about 100 Hz to about 300 Hz, or about 100 to 200, 200 to 300 or 150 to 250 Hz, e.g. about 100, 150, 200, 250 or 300 Hz.
Electrolyte: A suitable electrolyte is sodium sulfate: 0.95 mol/L, sulfuric acid 0.05 mol/L, in water. More generally, it may be an alkali metal sulfate, phosphate, halide or nitrate. The electrolyte may be maintained at a pH of from about 0 to about 7, or about 0 to 5, 0 to 3, 0 to 2, 0 to 1, 1 to 3, 2 to 5, 2 to 7, 5 to 7 or 1 to 2, e.g. about 0, 0.5, 1, 1.5, 2, 2.5, 3, 3.5, 4, 4.5, 5, 5.5, 6, 6.5 or 7. The electrolyte may be a liquid or a gel or a hydrogel. It may be protic. It may be aqueous (either an aqueous liquid or an aqueous gel or hydrogel).
Electrolysis voltage (i.e. the potential between the second and third electrodes): about −0.5 to about −5V, or about −2 to −5, −3 to −5, −1.5 to −4. −1.5 to −3 or −2 to −4V, e.g. about −0.5, −1.0, −1.5, −2, −2.5, −3, −3.5, −4, −4.5 or −5V.
Electrolysis current: about 10 to 100 mA/cm², or about 10 to 80, 10 to 50, 10 to 30, 20 to 100, 50 to 100, 20 to 80 20 to 50 or 50 to 80 mA/cm², e.g. about 10, 20, 30, 40, 50, 60, 70, 80, 90 or 100 mA/cm².

Other aspects of the apparatus that may be used include:
Catalyst: Cu, Ag, Ni, Ti, Au, Pt, Al, Ta, Ir, Pd or other suitable metal. The metal may be a catalytic metal. It may be a transition metal. It may be a metal from any one of Groups 9, 10, 11 or 12, or Group 5 or Group 13. It may be a blend, alloy or combination of any two or more such metals. It may be a metal oxide, an organic ligand, a catalytic polymer, MOF (metal organic framework) or COF (covalent organic framework) based catalyst, a molecular sieve, carbon, graphene, diamond, an ionic liquid, an enzyme, an inorganic catalyst or some other suitable catalyst.
Discharge zone thickness: about 1 to about 50 mm, or about 5 to 50, 5 to 20, 10 to 50, 10 to 50, 10 to 20, or 20 to 50 mm, e.g. about 1, 5, 10, 15, 20, 25, 30, 35, 40, 45 or 50 mm.
Distance between high voltage electrode and the fourth electrode if present: about 0.5 to about 5 mm, or about 0.5 to 2, 0.5 to 1, 1 to 5, 2 to 5 or 1 to 3 mm, e.g. about 0.5, 1, 1.5, 2, 2.5, 3, 3.5, 4, 4.5 or 5 mm.
Gas diffusion layer (support) thickness: about 10 to about 250 mm, or about 10 to 200, 50 to 150, 100 to 250, 150 to 250 or 100 to 200 mm, e.g. about 10, 20, 50, 100, 150, 200 or 250 mm.
Catalyst layer thickness: about 20 to about 500 nm, or about 50 to 250, 100 to 250, 150 to 250, 20 to 200, 20 to 100, 20 to 50, 50 to 200, 100 to 500, 100 to 200 or 50 to 100 mm, e.g. about, 20, 30, 40, 50, 100, 150, 200, 250, 300, 400 or 500 nm.
Electrolysis zone thickness: about 5 to about 100 mm, or about 5 to 50, 5 to 20, 10 to 100, 10 to 50, 10 to 20, 50 to 100 or 20 to 50 mm, e.g. about 5, 10, 15, 20, 25, 30, 35, 40, 45, 60, 55, 60, 65, 70, 75, 80, 85, 90, 95 or 100 mm.
Dielectric layer: about 0.1 to about 10 mm thick, or about 0.1 to 5, 0.1 to 2, 0.1 to 1, 0.1 to 0.5, 0.5 to 10, 1 to 10, 5 to 10 or 1 to 5 mm thick, e.g. about 0.1, 0.2, 0.3, 0.4, 0.5, 1, 2, 3, 4, 5, 6, 7, 8, 9 or 10 mm thick. For example it may be a 1 mm thick alumina layer.

The above parameters should be taken as guidance only. As discussed earlier, these may vary as the apparatus is scaled up or down so as to meet desired criteria such as apparatus size or production rate. Adjustment of these parameters is a routine matter for the skilled person.

The present invention may use a second electrode which may comprise a gas diffusion layer and a catalyst layer. The gas diffusion layer functions as a support layer for the catalyst layer, and as a conduit for the plasma to pass to the catalyst layer. It is thought that the transient species in the plasma are converted to product (e.g. ammonia) by the catalyst under the influence of the potential between the second and third electrodes.

As discussed, the apparatus of the invention may be used to generate products such as ammonia. In order to produce ammonia, it is necessary to use a nitrogen containing gas as the feed gas which passes through the discharge zone. Suitable gases include nitrogen, air and mixtures of nitrogen with one or more other gases, for example carbon dioxide, carbon monoxide, methane, helium, neon, argon, oxygen, nitrogen oxides and mixtures of any two or more of these. In order to achieve satisfactory production rates, the concentration of nitrogen in the gas may be at least about 5%, or at least about 10, 15, 20, 25, 30, 35, 40, 45, 50, 60, 70, 80 or 90%, or may be about 5, 10, 15, 20, 25, 30, 35, 40, 45, 50, 60, 70, 80, 90, 95 or 100%. The gas may also contain water vapour. This may serve as a proton source for generating ammonia. Other possible proton sources include gaseous hydrogen in the gas and/or hydrogen-containing substances (e.g. water) in the electrolyte used in the electrolysis zone. A further option, as shown in FIG. 3G, is that protons are provided by hydrogen, methane or water vapour through the membrane to the cathode in the absence of a liquid electrolyte.

An important aspect of the invention is that transient species from the discharge zone pass into the electrolysis zone. It is hypothesized that at least some of these transient species may form complexes with, or at least adhere to, the catalytic metal of the second electrode if present. This may render them more susceptible to electrolysis to form desired products, i.e. it may facilitate electrocatalysis of the transient species. Accordingly, the time for the gas/plasma mixture to pass from the discharge zone (where the transient species are formed) to the electrolysis zone (where they are subjected to catalysis, optionally electrocatalysis) may be shorter than the time required for the transient species to decay to more stable products (e.g. nitrate and nitrite). This may be achieved by appropriate choice of a pressure difference between the discharge zone and the electrolysis zone, as well as the thickness and/or pore size of the second electrode. These parameters are discussed elsewhere herein. In some instances it is thought that complexation or adhesion of the transient species with/to the catalytic metal or catalytic non-metal may extend their lifetimes, facilitating their eventual electrolysis in the electrolysis zone.

The following discussion outlines the use of N₂ and air as the inlet gas. However the inventors have examined a range of different inlet gases. It is possible to use many different gases and to tune the plasma/inlet parameters to obtain target products. In the examples below, the results for the use of air are presented, however mixtures of N_{2/02}, N₂/CO2 along with H₂O also show promise. It should be further noted that the system could also be adapted for use for CO2 conversion. For example, if the inlet gas contains both nitrogen and carbon dioxide, the system may produce urea.

It also should be noted that the plasma-electrolysis design that uses Surface Dielectric Barrier Discharge (SDBD) and Gas-Diffusion-Layer (GDL) Membrane Electrode Assembly (MEA) electrolyzer is not the only combination that may be used. To date, a range of different plasma reactors and electrolyzers have been tested, including but not limited to double dielectric discharge (DBD), glow discharge (GD), corona discharge (CD), microfluid reactor, H-cell and zero-gap reactor. We present herein a detailed design based on the SDBD-GDL-MEA. However, other reactor designs may also show promising results. Additionally, the plasma power supplies that drive the plasma reactors include, but are not limited to, AC, DC, micro-second pulsed, nano-second pulsed, and pulsed modulated plasma power supplies.

There are several developed approaches to gain desired products. As FIGS. 3A-G illustrate, the final products can be either collected in an electrolyte or gas outlet depending on the practical needs.

### Plasma-Electrocatalysis Conversion of N₂

A major barrier to the eNRR process is the high stability of N₂ and its low solubility in typical electrolytes. The inventors have overcome these challenges by combining atmospheric low temperature plasma activation with GDL-MEA electrocatalysis. Non-thermal plasma (NTP), also called cold plasma, is a mixture of gases where partial ionization causes the non-equilibrium between the temperature of the electrons (10⁴-10⁵ K) and that of heavy particles (molecules, atoms, ions and radicals), which enables the whole medium to act at or near room temperatures. In NTPs, N₂ molecules can be activated through three different pathways, including electron impact excitation, dissociation and ionization. The main N₂ electronic impact reactions and corresponding energy are: rotational and vibrational excitation (0.29 eV)<electronic excitation (6.17 eV)<dissociation (9.75 eV)<ionization (15.6 eV). From the literature and experimental results, the rotational and vibrational excitation pathways may be the key reactions of this process.

There are several important parameters for manipulating the plasma-electrolysis process: (i) Plasma discharge parameters that alter the distribution and energy of plasma activated species; (ii) Electrocatalysis voltage and electrocatalyst selection which govern electrolysis selectivity, activity, and productivity; and (iii) Plasma-electrolysis cell design parameters of distances and SDBD component shape will influence mass transfer and plasma species density. Operating conditions of gas flow rate, electrolyte flow rate, overall temperature and pressure can influence the plasma properties or electrolysis performance, but are considered as non-critical factors.

N₂(g)+2H₂O(l)+6H⁺(aq.)+6e⁻

[symbol]

2NH₃·H₂O (aq.)(E⁰=0.092 V vs. NHE) (Equation 1)

2H⁺(aq.)+2e⁻ [symbol] H₂(g)(E⁰=0.00 V vs. NHE) (Equation 2)

### Examples

In the following examples, the high voltage electrode was separated from the discharge zone by an alumina dielectric plate coated on the discharge zone side with PTFE. The earth (fourth) electrode was a mesh electrode constructed from stainless steel. It was about 0.55 mm thick with a hole size of about 3-5 mm. The second electrode was constructed as shown in Tables 1 and 2. P50T gas permeable carbon fibre paper was obtained from AvCarb®. It contained approximately 20% PTFE in order to enhance its hydrophobicity. Nano-Cu and Nano-Ag refer to P50T loaded with about 1 mg/cm² of nanoparticulate (<50 nm mean particle size) copper or silver respectively. These nanoparticulate metals were obtained from Sigma-Aldrich and were deposited on the face of the P50T which adjoined the electrolysis zone. The apparatus is shown in FIG. 3A, in which catholyte and anolyte are separated by an ion exchange membrane. This serves to reduce the possibility of oxidation of ammonia at the anode.

The potential difference between the high voltage and earth electrodes was maintained at 5 kV and between the second and third electrodes at −5V. The electrolyte was sodium sulfate 0.95 mol/L and sulfuric acid 0.05 mol/L, in water. The temperature was about 24-28° C. Inlet gas pressure was around 1 atm. Nitrogen was high purity (99.999%).

The electrolysis zone was separated into a catholyte and an anolyte zone by an ion exchange membrane. The same electrolyte (as described above) was used in each of these zones.

In a first example, pure nitrogen was used as the gas entering the electrolysis chamber. In this example, the catholyte and anolyte are both 40 mL 0.1M H₂SO₄ with 0.9M Na₂SO₄. The catalyst was prepared by spraying 2 mL dispersed nanoparticles (Ag nanopowder, <150 nm particle size, 99% trace metals basis, 484059 SIGMA-Aldrich; Cu nanopowder, 25 nm particle size (TEM) 774081 SIGMA-Aldrich) on commercial carbon papers (AvCarb P50T). The gas was Nitrogen Ultra High Purity Grade Compressed from BOC Australia. Gas flow rate was 20 sccm, electrolyte flow rates are 40 sccm. The plasma power source was CTP-2000K from Suman (Nanjing, China), applied voltage 6 kV. Electrochemical station from Metrohm Autolab Multichannel module (M204), applied voltage is-5V (vs. Ag/AgCl, KCl sat.). The results are shown in Table 1 and in FIG. 4.

TABLE 1
Plasma-electrolysis performance of N₂ using circulating aqueous product batch
process. (1 cm² active area, 40 mL 0.05M H₂SO₄ 0.95M Na₂SO₄ catholyte, 20 sccm
gas flow rate, 40 sccm electrolyte flow rate, catalyst loading at 10 mg cm²,
plasma applied voltage at 5 kV, electrolysis applied voltage at −5 V)

| | P50T | P50T | P50T | Cu | Ag |
|---|---|---|---|---|---|
| | Carbon | Carbon | Carbon | nanoparticle- | nanoparticle- |
| | Paper | Paper | Paper | sprayed | sprayed |
| | (control) | (control) | (control) | P50T | P50T |
| Plasma Discharge | 0 | 450 | 450 | 450 | 450 |
| Work (J) | | | | | |
| Electrolysis Work (J) | 153 | 0 | 134 | 260 | 115 |
| Total Work (J) | 153 | 450 | 584 | 710 | 565 |
| Time of Operation (s) | 1,200 | 1,200 | 1,200 | 1,200 | 1,200 |
| Total NH₃ Production | 0 | 0 | 1.75 | 14.75 | 29.28 |
| (μmol) | | | | | |
| Gas Inlet | N₂ (5.0) | N₂ (5.0) | N₂ (5.0) | N₂ (5.0) | N₂ (5.0) |
| Flow Rate (sccm) | 20 | 20 | 20 | 20 | 20 |
| NH₃ Production Rate | 0 | 0 | 0.09 | 0.75 | 1.49 |
| (mg h⁻¹) | | | | | |
| Catalyst Performance | 0 | 0 | 1.4 | 12.3 | 24.4 |
| (nmol cm⁻² s⁻¹) | | | | | |
| Energy Efficiency | N/A | N/A | 5,435 | 786 | 315 |
| (kWh kg⁻¹) | | | | | |
| Faraday Efficiency | N/A | N/A | 2.1 | 16.8 | 36.2 |
| (%) | | | | | |

### Plasma-Electrocatalysis Conversion of Air

Compared to the pure N₂ plasma-electrolysis process, the use of air is more desirable for industry. It should be noted that the developed plasma-electrolysis process can be operated under mild conditions and has favourable compatibility with sustainable energy resources of wind and solar power, providing the opportunity for a P2X strategy and decentralized NH₃ production.

The inventors are uncertain of the details of the mechanism of the present process. It appears unlikely that atmospheric non-thermal air plasma could provide sufficient NOₓ species at the energy density and temperature used. The inventors hypothesise a N₂ direct activated reduction and O₂-assisted N₂ reduction.

Results of the experiment using air as a feed gas are shown in FIG. 5 and in Table 2.

TABLE 2
Plasma-electrolysis performances of air using circulating aqueous product batch
process. (1 cm² active area, 40 mL 0.05M H₂SO₄ 0.95M Na₂SO₄ catholyte, 20 sccm
gas flow rate, 40 sccm electrolyte flow rate, catalyst loading at 10 mg cm²,
plasma applied voltage at 5 kV, electrolysis applied voltage at −5 V)

| | P50T | P50T | P50T | Cu | Ag |
|---|---|---|---|---|---|
| | Carbon | Carbon | Carbon | nanoparticle- | nanoparticle- |
| | Paper | Paper | Paper | sprayed | sprayed |
| | (control) | (control) | (control) | P50T | P50T |
| Plasma Discharge | 0 | 450 | 450 | 226 | 450 |
| Work (J) | | | | | |
| Electrolysis Work (J) | 172 | 0 | 56 | 25 | 74 |
| Total Work (J) | 172 | 450 | 506 | 251 | 524 |
| Time of Operation (s) | 1,200 | 1,200 | 1,200 | 600 | 1,200 |
| Total NH₃ Production | 0 | 0 | 14.39 | 31.90 | 20.70 |
| (μmol) | | | | | |
| Gas Inlet | Air | Air | Air | Air | Air |
| | (Industrial | (Industrial | (Industrial | (Industrial | (Industrial |
| | Grade) | Grade) | Grade) | Grade) | Grade) |
| Flow Rate (sccm) | 20 | 20 | 20 | 20 | 20 |
| NH₃ Production Rate | 0 | 0 | 0.734 | 3.25 | 1.06 |
| (mg h⁻¹) | | | | | |
| Catalyst Performance | 0 | 0 | 12.3 | 53.2 | 17.3 |
| (nmol cm⁻² s⁻¹) | | | | | |
| Energy Efficiency | N/A | N/A | 574 | 110 | 414 |
| (kWh kg⁻¹) | | | | | |
| Faraday Efficiency | N/A | N/A | Unknown | Unknown | Unknown |
| (%) | | | | | |

A further experiment was conducted in order to illustrate the need for both plasma and electrolysis in the generation of ammonia in the process of the invention. Thus plasma-electrolysis ON-OFF tests were performed to investigate the dependence of plasma and electrolysis and the synergy effect of the two in generating ammonia. In this experiment, the plasma and electrolysis were controlled ON and OFF for 5 minute periods as shown in FIGS. 8A-B. For each sampling time points, 500 μL catholyte samples were taken each minute, and 500 μL of MilliQ water were added into the catholyte for replenishment. A −1.0 V (vs. Ag/AgCl sat. KCl) voltage was applied on working electrode, and N₂ plasma was set to 4.3 kV. Ammonia was detected in the catholyte by means of the well-known Nessler's reagent method. FIG. 8A clearly shows that ammonia concentration increases only during those periods in which high voltage was applied in the discharge zone and low voltage was applied in the electrolysis zone. Neither of these voltages applied without the other generated ammonia. This supports the proposed mechanism of ammonia generation in which active species generated in the plasma pass into the electrolysis zone and are then electrolysed to generate ammonia. FIG. 8B confirms that the current flowed in the electrolysis zone during those periods when voltage was applied between the low voltage (second and third) electrodes bounding the electrolysis zone, even though ammonia was not generated unless high voltage was also applied in the discharge zone.

1. An apparatus for producing ammonia comprising:
a discharge zone configured to accept inflow of a nitrogen containing gas therethrough,
a high voltage electrode capable of generating a high voltage discharge within the discharge zone, wherein inflow gas within the discharge zone produces transient plasma species in presence of an electric discharge by the high voltage electrode, and
an electrolysis zone bounded by a second electrode and a third electrode, wherein:
the second and third electrodes are low voltage electrodes, and
the second electrode is gas permeable and separates the electrolysis zone from the discharge zone; and
a catalytic material within and/or at the boundary of the electrolysis zone;
wherein movement of the transient species from the discharge zone through to the electrolysis zone occurs in a timeframe which is less than the lifetime of the transient species, wherein the plasma species undergo electrolysis to produce ammonia.

2. The apparatus of claim 1 comprising a fourth electrode, said fourth electrode being disposed within the discharge zone being gas permeable allowing passage of a gas therethrough, whereby the high voltage discharge occurs between the high voltage electrode and the fourth electrode.

3. The apparatus of claim 2 wherein the fourth electrode is an earth electrode.

4. The apparatus of claim 1 further comprising a dielectric barrier between the high voltage electrode and the discharge zone, wherein the dielectric barrier is impermeable to a gas passing through the discharge zone.

5. The apparatus of claim 1 wherein the second electrode comprises substantially of the catalytic material in the form of a nanostructured catalytic metal, the catalytic metal selected from the group consisting of copper, silver, nickel, titanium, gold, platinum, aluminium, tantalum, iron, ruthenium and mixtures, blends, combinations and alloys of any two or more of these, on a gas permeable support.

6. The apparatus of claim 5 wherein the nanostructured metal is in and/or on a face of the second electrode abutting the electrolysis zone.

7. The apparatus of claim 5 wherein the gas permeable support is hydrophobic.

8. The apparatus of claim 1 wherein the electrolysis zone contains an electrolyte in contact with both the second and third electrodes, wherein the apparatus is configured to allow the electrolyte to flow through the electrolysis zone.

9. The apparatus of claim 8 wherein the electrolyte is a liquid electrolyte.

10. The apparatus of claim 8 configured to allow the electrolyte to flow through the electrolysis zone.

11. The apparatus of claim 1 wherein the electrolysis zone is divided into two half-cells by an ion exchange membrane such that a first half-cell is bounded by the second electrode and the ion-exchange membrane, and a second half-cell is bounded by the ion-exchange membrane and the third electrode.

12. The apparatus of claim 11 wherein a low voltage is applied between the gas permeable second electrode and the third electrode in the second half-cell disposing the plasma species to electrocatalysis within the electrolysis zone so as to generate ammonia from the reactive species.

13. A hybrid plasma electrocatalytic system for producing ammonia comprising:
a discharge zone and a high voltage electrode, wherein the discharge zone is configured to receive a flow of gas therethrough and the high voltage electrode is adapted to generate an electric discharge in the discharge zone to produce a transient non-thermal plasma species from the inflow of gas or gas mixtures such as air and/or nitrogen;
a gas impermeable dielectric barrier shielding the high voltage electrode from the discharge zone;
a second and third electrode forming an electrolysis zone therebetween separating the electrolysis zone from the discharge zone, the second electrode comprising a nanostructured catalytic metal on a gas and/or plasma permeable support wherein the metal is located in and/or on a face of the second electrode abutting the electrolysis zone, and wherein the second and third electrodes being low voltage electrodes connectable to a low voltage source;
an electrolyte in the electrolysis zone in contact with the second and third electrodes, the second electrode adapted to substantially prevent ingress of the electrolyte into the discharge zone;
wherein the electrolysis zone is divided into anolyte and catholyte zones by an ion exchange membrane such that a first half-cell is bounded by the second electrode and the ion-exchange membrane, and a second half-cell is bounded by the ion-exchange membrane and the third electrode;
a fourth electrode located in the discharge zone being gas permeable and wherein the electric discharge occurs between the high voltage electrode and the fourth electrode;
wherein inflow gas within the discharge zone produces transient plasma species in presence of an electric discharge by the high voltage electrode;
wherein the plasma species in the discharge zone contains highly reactive nitrogen species which diffuse through the gas permeable (second) electrode into the first half-cell;
wherein a low voltage is applied between the gas permeable (second) electrode and the electrode (third electrode) in the second half-cell disposing the plasma species to electrocatalysis within the electrolysis zone so as to generate ammonia from the reactive species; and
wherein ammonia exits the system through an outlet in the half-cell in which it is generated and isolated from the stream of electrolyte.

14. A process for making ammonia comprising:
providing a system according to claim 13;
passing a nitrogen containing gas through the discharge zone;
generating a plasma within the nitrogen containing gas in the discharge zone;
passing transient species generated in the discharge zone through the second electrode into the electrolysis zone; and
electrolysing the transient species in the electrolysis zone to produce ammonia;
wherein pressure of the nitrogen containing gas in the discharge zone is sufficient to transport the transient species produced within the plasma to the electrolysis zone in less time than the lifetimes of the transient species;
absorbing at least a part of the ammonia into an electrolyte in the electrolysis zone; and
recovering the ammonia from the electrolyte.
